(19) United States
(12) Patent Application Publication
(10) Pub. No.: US 2009/0123653 A1
(43) Pub. Date: May 14, 2009

(54) Resin Coating Method For The Edge Of A Machined Part, The Corresponding Resin Coating Device And The Part Edge Thus Protected

(75) Inventors: Jacques Chenebaud, Arrabloy (FR); Jerome Luthon, Saint Jean De Braye (FR); Didier Boulogne, Saint Gondon (FR)

Correspondence Address: CARLSON GASKEY & OLDS, 400 W MAPLE STE 350, BIRMINGHAM, MI, 48009, US

(73) Assignee: OTIS ELEVATOR COMPANY, Farmington, CT (US)

(21) Appl. No.: 11/720,444

(22) PCT Filed: Nov. 30, 2004
(86) PCT No.: PCT/IB04/03945

§ 371 Date: May 30, 2007

(51) Int. Cl. B05C 5/00; B05D 3/02; B05D 1/02

(52) U.S. Cl. 427/385.5; 427/421.1; 118/300

(57) ABSTRACT

The method according to the invention to apply resin (1) over the edge (3) of a machined part in order to protect the handling operator from possible injuries caused by said edge (3) , is characterized in that:—said resin (1) is prepared to be made fluid and usable by a coating device applied over said edge (3) ,—said edge (3) is coated with resin by means of said coating device being applied in translation along the edge (3) so as to apply a regular strip of resin on said edge (3) , on its front and sides, and—said applied strip of resin is cured so that it hardens and adheres to said edge (3) and strongly covers its machining imperfections so that the part can be caught by hand safely.

This invention relates to a resin coating method for the edge of a machined part aimed at protecting the edge and make its handling safer, to the corresponding resin coating device and to the part edge thus protected.

Machined metal parts are known to sometimes have machined edges that are rough, sharp or uneven and can be dangerous when seized by an operator to handle the parts. These edges can be processed mechanically to allow them to be seized by hand, e.g. by burring, bending, etc., but these operations are noisy, produce dust, are difficult to implement in some places, etc.

This invention aims at correcting these disadvantages and proposes a resin coating method for the edge of a machined part designed to protect the handling operator from possible injuries caused by said edge, characterized in that:
said resin is prepared to be made fluid and usable by a coating device applied over said edge,
said edge is coated with resin by means of said coating device being applied in translation along the edge so as to apply a regular strip of resin on said edge, on its front and sides, and
said applied strip of resin is cured so that it hardens and adheres to said edge and strongly covers its machining imperfections so that the part can be caught by hand safely.

Said resin is advantageously a hotmelt adhesive that is applied in a hot fluid state over said edge by the coating device and hardens immediately in air at room temperature.

The coating device is of the gun type with a fluid resin outlet nozzle, said gun being translated while applying its nozzle along said edge manually, in a regular displacement along said edge.

In order to obtain a regular and easy spread of the resin along said edge with the coating device, the nozzle is provided with a slot in its resin outlet part, which is shaped in accordance with the edge to be treated, within an application clearance, and contains at least one internal groove restricting the application of the resin strip on said edge.

When coating the straight edges of a metal sheet, said slot is U-shaped and complementary of the rectangular cross-section of the sheet edge within the clearance, in order to allow guiding the nozzle by contact in translation along the edge, wherein the slot has at least one bottom part facing the resin outlet hole and corresponding to the side of the edge, as well as two opposing side walls designed to be accommodated on either side of the edge, each of the bottom and side walls of the slot comprising an internal groove into which the resin spreads in contact with the edge and which restricts the resin strip applied on the edge, its front and sides and over a given width and thickness during the translation of the nozzle along the edge.

The invention also relates to the coating device designed to implement the coating method described above, as well as the part edge lined with coating resin by the implementation of the method.

The invention is illustrated hereafter by an exemplary embodiment with reference to the drawings, wherein:

FIG. 1 shows a framework part with edge areas that are to be coated with resin in order to protect an operator handling this part;

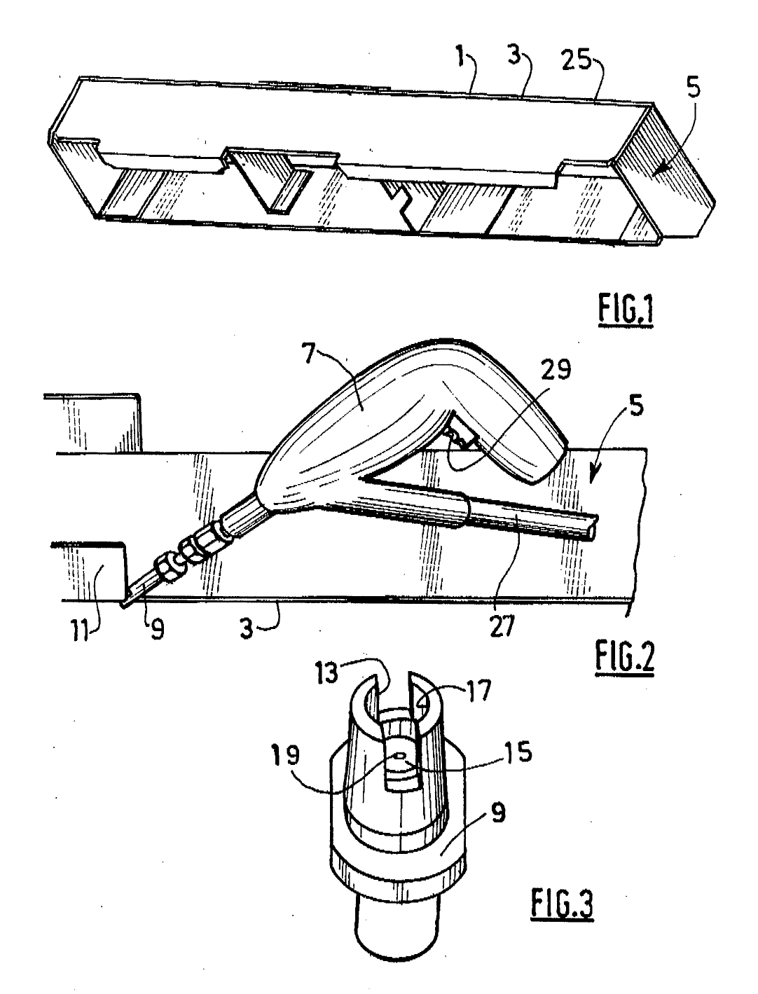

FIG. 2 shows the application of resin with a coating gun along a metal sheet;

FIG. 3 is a perspective view of the resin outlet nozzle of the coating gun;

FIG. 4 is an elevation view of this nozzle applied along an edge of the metal sheet;

FIG. 5 is a top view of the nozzle; and

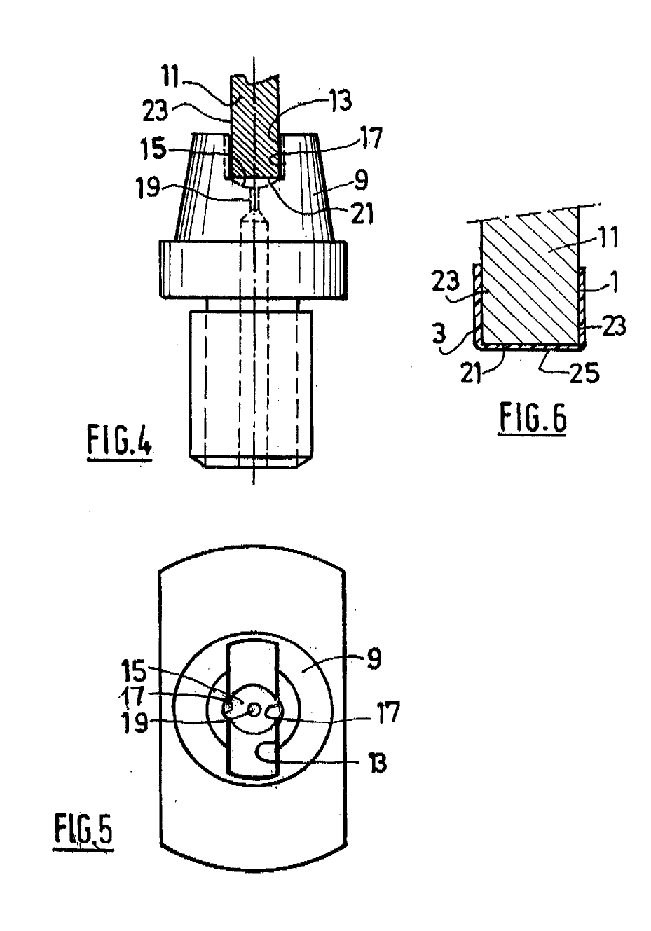

FIG. 6 is a cross-section of the coated edge of the metal sheet.

Referring to the drawings, and in particular to FIGS. 1-3, the resin coating method of the invention is designed to apply resin 1 over the edge 3 of a recently machined part 5 in order to allow a person to seize the coated edge 3 of that part in order to handle it for further processing. This part 5 can be a framework part such as represented by FIG. 1, which must be assembled with other elements into an assembly. Only the parts to be seized 3 are coated with resin. These resin-coated parts 3 are easily visible for the operator so that he knows that there is no risk of injury if he seizes them. In fact, the resin coating forms a protective bead around the edge and covers the rough spots produced by machining.

On the other hand, it should be noted that in conventional mechanical abrasion methods, it is difficult to visually recognize whether the edge has been processed or not, so that the edge must be processed over a greater length to allow the operator to seize it safely.

As mentioned previously, the resin is applied with a hand-held coating gun 7 that is displaced along the edge 3 to be processed (FIGS. 2 and 3), with its resin outlet nozzle 9 applied in contact with the edge to be processed 3.

This nozzle 9 is made of brass or copper. It is designed to process a defined straight sheet metal edge 3, in the illustrated case, corresponding to a given thickness of a metal sheet 11. It comprises a U-shaped slot 13 opened downwards and having a cross-section complementary of that of the edge to be processed 3 (straight edge of a metal sheet 11) within the application clearance (FIG. 4).

This slot 13 contains three grooves 15, 17 (FIGS. 4 and 5) arranged level with the resin outlet hole 19 of the nozzle. The bottom groove 15 of the slot, corresponding to the middle arm of the U, is in direct contact with the hole 19 and centered thereon. It has the shape of a cup. The other two grooves 17 are opposite each other and extend longitudinally along each of the opposite inside surfaces of the U and to the end thereof, at right angles with the bottom.

These grooves 15, 17 allow the fluid resin (FIG. 4) to spread on the front 21 and sides 23 of the edge while the nozzle 9 is being translated along the edge 3 at a regular, approximately constant and determined speed.

The applied resin strip 25 substantially matches the inside cross-section of the slot 13 (FIG. 6).

The coating resin used is advantageously a hotmelt adhesive coming as granules or solid bars at room temperature and hot-fusible at about 170-180° C.

This adhesive is liquefied in an adequately heated tank (not shown) and supplied under pressure to the coating gun 7 by means of a hose 27 connected to the gun 7 and to its coating nozzle 9. The exit of the adhesive at the same time as the gun is translated is obtained by a trigger 29 of the gun, which is drawn for coating and released to stop. As soon as the adhesive is applied on the edge 3, it hardens instantly forming a solid and visible whitish bead 25 that can be seized by hand to handle the part 5 a few seconds after coating.

The coating method is very simple and fast to implement both for coating and for hardening.

The hotmelt adhesive is first heated in its tank until liquid, then the gun 7 is applied with its nozzle 9 on the edge 3 of the metal sheet 11 to be coated, with the slot 13 accommodating the edge 3 and contacting its entire surface. At the same time as the trigger 29 of the gun is pulled to make the adhesive flow out of the hole 19 of the nozzle, the gun 7 is displaced along the edge 3 in a regular movement and at a substantially constant translation speed, so as to form a regular strip of adhesive 25 on the edge, as illustrated by FIG. 6.

Once the edge has been coated in the areas to be seized by the operator on the part to process, the instantaneous hardening thereof allows the operator to almost immediately handle the part thus treated and be sure to safely hold the visible coated edges.

It should be noted that in a variation of the invention, the slot 13 can have a variable (but regular) shape adapted to the cross-section of the edge to be treated, and can be e.g. triangular, round or other.

In addition, the nozzle 9 can be made of a heat-conducting material and its slot 13 must advantageously have a clearance of 0.5 mm to be well guided along the edge to be treated, wherein the bottom of the slot can have a variable shape according to the profile desired for the coating.

1-9. (canceled)

10. A method to apply resin over an edge of a machined part in order to protect an operator while manually handling the edge, comprising:
preparing the resin to be made fluid and usable by a coating device applied over the edge;
coating the edge with the fluid resin using the coating device applied in translation along the edge so as to apply a strip of resin on the edge on a front and each of two sides of the edge to thereby form a protective bead around the edge that covers any machining imperfections on the edge; and
curing the applied strip of resin so that the applied strip hardens and adheres to the edge and covers the any machining imperfections so that the edge can be manually handled.

11. The coating method of claim 10, wherein the resin is a hotmelt adhesive that is applied in a hot fluid state over the edge by the coating device and hardens immediately in air at room temperature.

12. The coating method of claim 10, wherein the coating device comprises a fluid resin outlet nozzle, and the method comprises applying the nozzle along the edge and manually moving the coating device along the edge.

13. The coating method of claim 12, wherein the nozzle is provided with a slot in a resin outlet part, which is shaped in accordance with the edge to be treated and contains at least one internal groove restricting the application of the resin strip on the edge to obtain a desired spread of the resin along the edge.

14. The coating method of claim 13, wherein the slot has a shape corresponding to the cross-section of the edge to be treated.

15. The coating method of claim 13, wherein the nozzle is made of a heat-conductive material.

16. The coating method of claim 13, wherein the slot has an application clearance of approximately 0.5 mm to follow the cross-section of the edge to be treated.

17. The coating method of claim 13, wherein the edge is a straight edge of a metal sheet, the slot is generally U-shaped and complimentary of a rectangular cross-section of the sheet edge within a selected clearance, to allow guiding the nozzle by contact and translation along the edge, wherein the slot has at least one groove facing a resin outlet hole facing a front of the edge and two opposing sidewalls designed to be accommodated on either side of the edge, each of the groove and sidewalls of the slot comprising an internal groove into which the resin spreads in contact with the edge and which restricts the resin strip applied on the front and sides over a given width and thickness during the translation of the nozzle along the edge.

18. A coating device comprising:
a resin outlet nozzle provided with a slot in a resin outlet part, which is shaped in accordance with an edge to be coated, the slot being configured to receive the edge within an application clearance, the slot contains at least one internal groove restricting the application of a resin strip on said edge.

19. The coating device of claim 18, wherein the application clearance is approximately 0.5 mm.

20. The coating device of claim 18, wherein the internal groove has a portion adjacent a hole of the resin outlet part and another portion on each of two opposing sidewalls configured to be accommodated on opposite sides of the edge.
